(19) United States
(12) Patent Application Publication
(10) Pub. No.: US 2004/0081834 A1
(43) Pub. Date: Apr. 29, 2004

(54) Thermoset resin laminated wood

(76) Inventor: Ming Der Sun, Kaohsiung Hsien (TW)

Correspondence Address: Leong C. LEI, PMB #1008, 1867 Ygnacio Valley Road, WALNUT CREEK, CA, 94598-3214, US

(21) Appl. No.: 10/281,170

(22) Filed: Oct. 28, 2002

(51) Int. Cl. B32B 25/20

(52) U.S. Cl. 428/447

(57) ABSTRACT

An improved structure of a thermoset resin laminated wood, essentially by having coated on the face of the laminated a mixture of powder TiO2 and a binding agent, then dried in an oven to form a practically transparent surface layer that reacts when exposed to a visible light to kill airborne microbes and degrade hazardous gases in the air to help clean the air without adapting to any other objects.

### BACKGROUND OF THE INVENTION

(a) Field of the Invention

The present invention is related to a thermoset resin laminated wood, and more particularly to one that helps clean the ambient air without incurring additional operation cost.

(b) Description of the Prior Art

Increased income means higher consumption power to improve one's living quality. When that comes to one's home or office, the interior space usually must be partitioned. Thermoset resin laminated wood for featuring smooth surface and various colors available to easily compromise the ambient environment, is a perfect choice and widely used as a face penal for partition. However, the thermoset resin laminated wood can be used strictly for decoration purpose. Furthermore, with the exception of a clean room, there are certain airborne microbes or hazardous gases, namely, ammonia, formaldehyde, and toluene existing in the room. Even though air purifier and ozone sterilization systems have been developed to filtrate and clean the air inside an enclosed space to provide clean air to prevent possible damage to human health by those airborne microbes and hazardous gases in the room. The shame is that such systems must be powered on to perform their functions as expected. Polluted air is continuously permitted into the room to undermine results of air purification and sterilization once the cleaning system is off. It takes initial purchase cost for having such a clean system. After the installation, comes the bill of power consumption and subsequent service costs to keep the system going. The quality of function of such a cleaning system depends on its power. In case of a larger room, the cleaning system with larger cleaning capacity must be provided at a cost not affordable to an average family.

### SUMMARY OF THE INVENTION

The primary purpose of the present invention is to provide an improved structure of a thermoset resin laminated wood that kills the airborne microbes and degrades hazardous gases present in the air. To achieve the purpose, the face of the laminated wood is coated with a mixture of TiO2 powder and a binding agent, and then the laminated wood is heated in an oven to form a practically transparent surface layer. When exposed to a light source, TiO2 contained in the surface layer is triggered into a highly reactive status of electronic excitement to kill any airborne microbes and degrades hazardous gases present in the air for providing a clean interior environment.

Another purpose of the present invention is to provide an improved structure of a thermoset resin laminated wood that achieves a significant saving otherwise would have been spent on purchasing and maintaining an air cleaning system. To achieve the purpose, the present invention takes advantage of any visible light that is available in any room provided with a lighting fixture since the present invention is capable of creating the electronic excitement simply by being exposed to such visible light.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is a process flow chart of the formation of the surface layer of the preferred embodiment of the present invention.

FIG. 3 is a chart showing the curve of degradation rate vs. time of the preferred embodiment placed in a 100 ppb toluene enclosed cabinet and exposure in the radiation from a certain light source under controlled time frame.

FIG. 4 is a chart showing the curve of degradation rate vs. time of the preferred embodiment placed in a 100 ppb toluene enclosed cabinet under natural degradation conditions without being exposed to the light source.

FIG. 5 is a view showing the general comparison between FIGS. 3 and 4.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

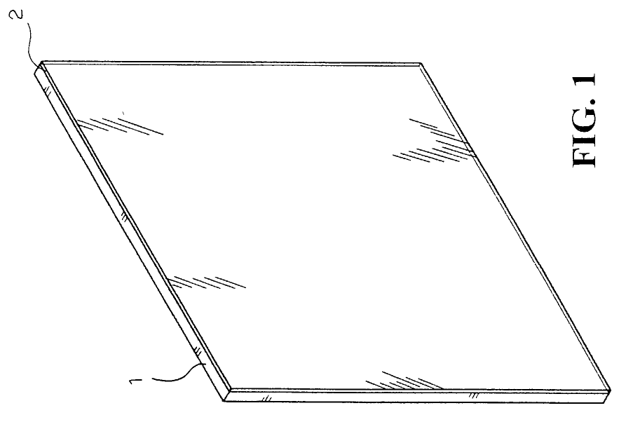

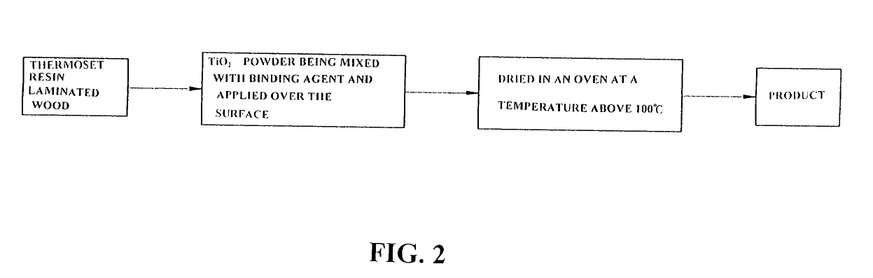

Referring to FIG. 1, a preferred embodiment of the present invention is essentially comprised of a surface layer 2 formed on a thermoset resin laminated wood 1 generally available in the market. As shown in the flow chart in FIG. 2, TiO2 powder mixed with a binding agent, silicone resin is consistently applied over the surface of the thermoset resin laminated wood 1. The coated laminated wood 1 is then dried in an oven at a temperature above 100 degrees centigrade. The organic ethers in TiO2 are quickly evaporated for TiO2 to fast bind to the laminated wood 1 (i.e. result of a hardening process) to create a practically transparent surface layer 2 on the face of the laminated wood 1.

With the surface layer 2, the binding between the laminated wood 1 and TiO2 provides higher hardness to withstand damage from friction or prevent scratch due to impact from other object to maintain its attractive appearance as a spatial partitioner. Whereas TiO2 contained in the surface layer 2 relates to a semiconductor substance, generally known as a photo catalyst, and the most frequently used one in photo catalysis. Once TiO2 is exposed to visible light (natural light or UV), electrons in electrovalent belt are excited to move into conduction belt to produce a electro-electronic hole pair, thus to increase the transmission speed of electros in oxidization and reduction in producing highly active radicals of strong oxidizing capability. Therefore, the surface layer 2 of the present invention reacts when subject to the radiation of a visible light source to use the resultant electronic hole produced in the electrovalent belt to forthwith oxidize organics. Furthermore, the radicals produced (e.g. negative oxygen radicals) could indirectly oxidize organics. Accordingly, with the photo catalysis, not only airborne microbes are killed but also those hazardous gases including ammonia, formaldehyde, and toluene in the air are degraded. Since the air in the space in public place or at home is usually not in stagnation, convection can be easily produced in the interior air whenever a door or a window is opened, or an electric fan or an air conditioner is activated to cause the air always in a flowing status. Therefore, the laminated wood 1 whether erected for partitioning or decoration purpose, consistently contact the air, thus to kill airborne microbes and degrade hazardous gases covering a wide area without interruption. The present invention maintains the interior air always in clean status without being affected by external factors, such as on/off or poor power the conventional air cleaning systems are subject to. The present invention is an effective and simple structure that helps clean the interior air quality by being exposed to the visible light source to achieve the same purpose as the conventional air cleaning system could do without additional costs of purchasing and maintaining the air cleaning system, and consumption of any additional energy.

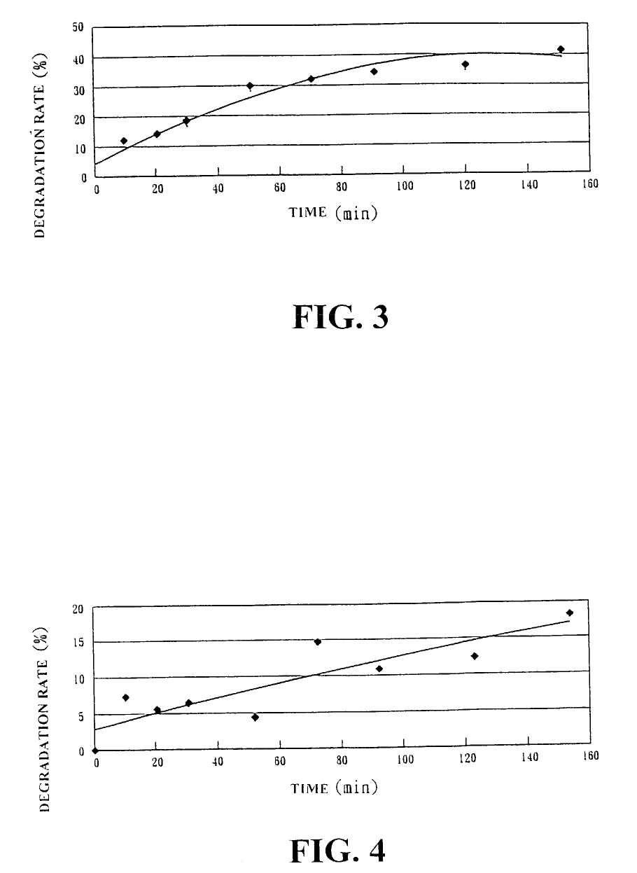

Now referring to FIG. 3 for a curve of degradation rate vs. time of the preferred embodiment of the present invention placed in an enclosed cabinet containing toluene of a density of 100 ppb, exposed to a UV from a light source with a given flux, it shows the toluene degradation rate tends to increase as the time increases, that is, the longer the preferred embodiment is exposed to the UV light, the reaction of photo catalysis gets longer to produce significantly stronger degradation by oxidization to reduce the toluene density in the cabinet.

As illustrated in FIG. 4, the curve shows a curve of degradation rate vs. time of the preferred embodiment of the present invention placed in an enclosed cabinet containing toluene of a density of 100 ppb, but without being exposed to the UV light source. Though the toluene degradation rate tends to increase as the time increases, the degradation rate is comparatively poor, resulting in the accumulation of surviving toluene density in the cabinet.

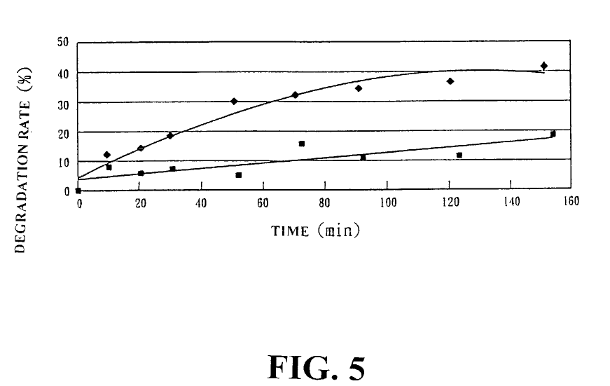

In FIG. 5, comparison of degradation rate of toluene with and without exposure to the UV light source as respectively illustrated in FIGS. 3 and 4. Wherein, the curve in diamond shape indicates the toluene density degradation result under the photo catalysis triggered by the preferred embodiment of the present invention while the curve in square shape shows the toluene density degradation result without being exposed to UV light. It appears that when subject to the UV light source, photo catalysis by the preferred embodiment of the present invention causes the toluene to be fast degraded to provide several folds of eliminating air pollutants efficiency when compared to the natural degradation of toluene without being exposed to the UV light.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a thermoset resin decoration laminated wood is essentially having provided a surface layer on the face of the laminated wood; TiO2 powder being mixed with a binding agent to coat on the laminated wood; the coated laminated wood being put in an oven; and the TiO2 being bound to the laminated wood.

2. An improved structure of a thermoset resin decoration laminated wood as claimed in claim 1, wherein, the binding agent relates to silicone resins.
